(19) United States
(12) Patent Application Publication
(10) Pub. No.: US 2002/0049862 A1
(43) Pub. Date: Apr. 25, 2002

(54) Method and apparatus for providing optical internetworking to wide area networks, metropolitan area networks, and local area networks using modular components

(76) Inventors: Glenn A. Gladney, Manalapan, NJ (US); Paul K. Wolfe JR., Naperville, IL (US)

Correspondence Address: BLANK ROME COMISKY & MCCAULEY LLP, THE FARRAGUT BUILDING, SUITE 1000, 900 17TH STREET, NW, WASHINGTON, DC, 20006, US

(21) Appl. No.: 09/982,104

(22) Filed: Oct. 19, 2001

Related U.S. Application Data
(60) Provisional application No. 60/242,079, filed on Oct. 23, 2000.

(51) Int. Cl. G06F 15/16

(52) U.S. Cl. 709/250; 709/203

(57) ABSTRACT

An arrangement providing optical internetwork to Wide Area Networks (WAN), Metropolitan Area Networks (MAN), and/or Local Area Networks (LAN) as a peripheral device using modular components. WANs can be defined to include wireless, SONET/SDH, or DWDM networks for long haul applications. MANs can be defined to include wireless, Synchronous Optical Network (SONET)/Synchronous Digital Hierarchy (SDH), or Wavelength Division Multiplexing (WDM) networks for Metro applications. The exemplary apparatus comprises of a printed circuit board (PCB) with a Small Computer System Interface (SCSI) connector, which provides the interface to a WEB, DataBase (DB), General-Purpose (GP) server, workstation, or PC. The SCSI Optical Device (SOD) provides gateway functionality to WAN, MAN, or LAN. SOD's processing is accomplished by one, two, or four processors depending on the OC rate of the optical (fiber) connection. Buffering of data is done by RAM memory located on the circuit board. The data is transmitted on the fiber using standard WAN or MAN protocols. The fiber connection is accomplished through a Network Interface Component (NIC) that consist of an eight way multiplex optical connector to the fiber and a standard Bus connector that interfaces to the circuit board. The NIC is removable and has eight optical frequencies. The SOD also has two slots for Personal Computer Memory Card International Association (PCMCIA) cards. The first PCMCIA card is required and provides software/firmware instructions for execution by the gateway processor(s). Without the first PCMCIA card, the SOD will not function. The second PCMCIA card is optional and provides an interface to perform field diagnostics and/or network management for trouble analysis via a LAN or TTY port.

### REFERENCE TO RELATED APPLICATION

The present application claims the benefit of U.S. Provisional Application No. 60/242,079, filed Oct. 23, 2000, whose disclosure is hereby incorporated by reference in its entirety into the present disclosure.

### TECHNICAL FIELD

This invention relates to optical networks and more specifically, to a method and apparatus for providing optical networking to Wide Area Networks (WAN) Metropolitan Area Networks (MAN), or Local Area Networks (LAN) as a peripheral device using modular components.

### BACKGROUND OF THE INVENTION

In the 1970s and 1980s, corporate data processing was performed by central computer centers in an efficient and cost effective method, the same is true with today's corporate network gateway systems. However, just as the central computing centers evolved into distributed computing systems of today due to the central computer centers inability to handle the increase workload and demand for more computing power, so is the path for network gateways. As optical bandwidth increases and additional services of multimedia mature such as video on demand and teleconferencing, the center network gateway system will become the performance bottleneck in the corporate network.

Also, the network gateway suffers the same down time ills, as did the central computer center. When the gateway system is down or out of service, all clients that depend on the gateway are disconnected from the corporate network. Today, having corporate network connection is just as important as it was to have the center computer systems up and running twenty years ago

When gateway functionality is added to a server or workstation in a distributed computing environment, the Central Processing Unit(s) (CPUS) cycles must be shared with network protocols and user's applications. As both network protocols and user's applications grow in complexity, both will demand more CPU cycles. This causes another performance problem with insufficient computing power.

Gateway systems provide firewall protection, which prevents unauthorized access to private computer environments. But a firewall only filters the lower levels of the ISO seven layers of network protocols. Examination of headers of the top level is not done, and, thus, a firewall does not offer protection against computer viruses.

When software and firmware new releases need to be installed, the gateway system needs to be placed off line from the network for several hours, sometimes days. The installations are very time consuming and require constant human intervention

And as copper coax and twisted pair wires are replaced with optical fiber, gateway systems need to be replaced (forklift process) which results in additional down time. This replacement method does not preserve the corporate investment in their copper infrastructure, which can serve as a back up network as the optical fiber network is being proven in.

When data responses are to be transmitted from the gateway system, the data can be received from the data source as an optical signal. The optical signal is translated into an electrical and regenerated as an optical signal. An additional performance gain could be obtained if the signal was preserved as an optical signal.

The present invention is directed to overcoming or at least reducing the efforts of one or more of the problems set forth above.

### SUMMARY OF THE INVENTION

These problems are solved and a technical advancement is achieved in the art by a method and apparatus that provides an optical internetwork gateway to Wide Area Networks (WAN), Metropolitan Area Networks (MAN), and/or Local Area Networks (LAN) using modular components. Advantageously, this invention receives messages requesting information, removes all protocol headers, and presents the request to the WEB server, Data Base server, or general-purpose computer as a peripheral device. Furthermore, the invention receives the corresponding information for the request, adds all protocol headers, and transmits the information to the appropriate destination.

In a method according to the preferred embodiment of this invention, a WAN, MAN, or LAN client sends a message requesting information from a specific server or peer client. A SCSI Optical Device monitors the WAN, MAN, or LAN for request associated with the server or peer client it is connected. When the SCSI Optical Device detects a message, it performs all seven (7) layers of protocol handling, firewall protection, and computer virus detection and presents the request to the server as a data item on the SCSI bus. When the information is located, it is returned as a data item on the SCSI bus to the SCSI Optical Device. The SCSI Optical Device adds the necessary protocol headers and transmits the requested information to the corresponding WAN, MAN, or LAN client.

An apparatus according to the preferred embodiment of this invention provides an optical internetworking to a WEB server, data base system or general-purpose system as a SCSI bus peripheral device. The apparatus comprises of a printed circuit board (PCB) with a SCSI bus connector for interfacing with associated server, a set of one, two, or four processors to perform encapsulation of data packets, and RAM memory for storing instructions and buffering data. The connectors are used for interfaces to the main circuit board of the apparatus. Advantageously, data information is encapsulated into packets for transmission by a first device, and a second device coupled to the first device and responsive thereto for receives packets and translates into appropriate signals for transmission onto a WAN, MAN, or LAN. The second device may comprise of digital signal processor, optical signal generator, multiplexing for used to transmit more then one signal simultaneously using either electronic digital signals or optical signals with appropriate WAN, MAN, or LAN connectors. The second device interfaces with the first device by using an electronic connector, optical connector, or a combination of both.

Advantageously, the instruction set and routing information comprises a first device is not restricted to a single protocol in ROM but can be dynamically updated to handle several different protocols for internetworking and a third device coupled to the first device and responsive thereto for providing software/firmware instructions and internetworking routing information. The third device may comprise a disk system or other writable, nonvolatile electronic device. Furthermore, the apparatus may include an interface for a terminal. A device to update the third device is also provided, wherein said updating device comprises a device for sending an update request to a file server either local and NFS file systems and a device responsive to a message from the file server for updating the third device.

### BRIEF DESCRIPTION OF THE DRAWING

A more complete understanding of the invention may be obtained from a consideration of the following description in conjunction with the drawing in which:

FIG. 1 is a block diagram illustrating the principles of this invention in the context as a peripheral SCSI bus device that connect to either a WAN, MAN, or LAN;

FIG. 2 is a block diagram of a SCSI optical device of FIG. 1 according to an exemplary embodiment of this invention;

FIG. 3A is a block diagram of a Network Interface Component (NIC) of FIG. 2 according to an exemplary embodiment of this invention;

FIG. 3B is a block diagram of a Network Interface Component (NIC) of FIG. 2 using the prior art of copper connectors according to an exemplary embodiment of this invention;

FIG. 4 is a block diagram of an extended SCSI optical device of FIG. 1 according to an exemplary embodiment of this invention;

FIG. 5 is a block diagram of a modified Network Interface Component (NIC) with the addition of an optical bus feed of FIG. 4 according to an exemplary embodiment of this invention

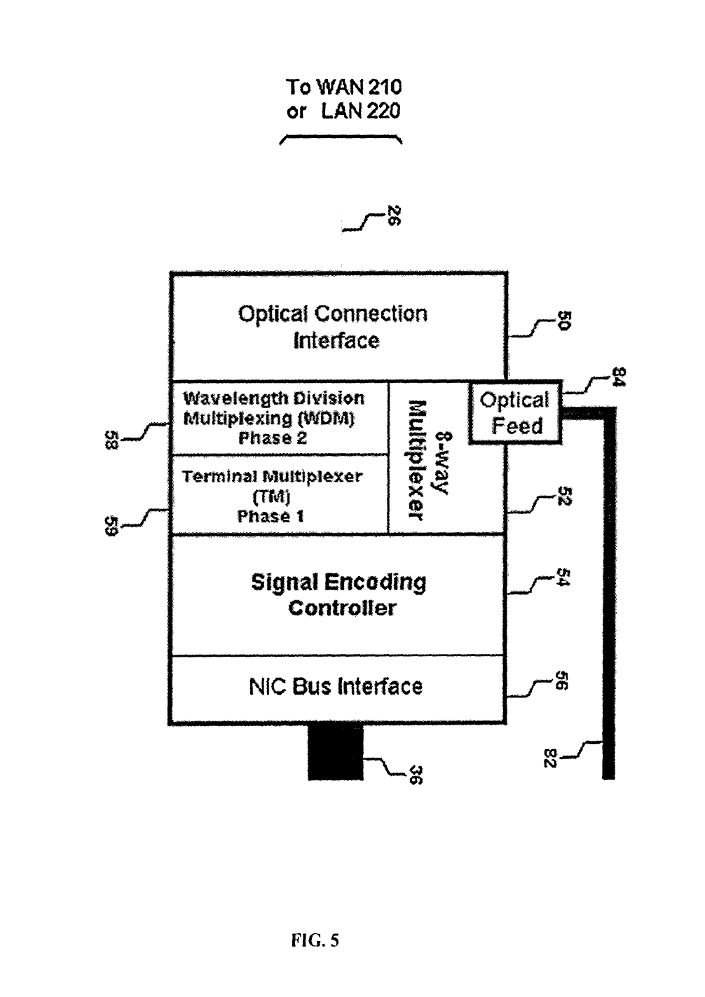

### DETAILED DESCRIPTION

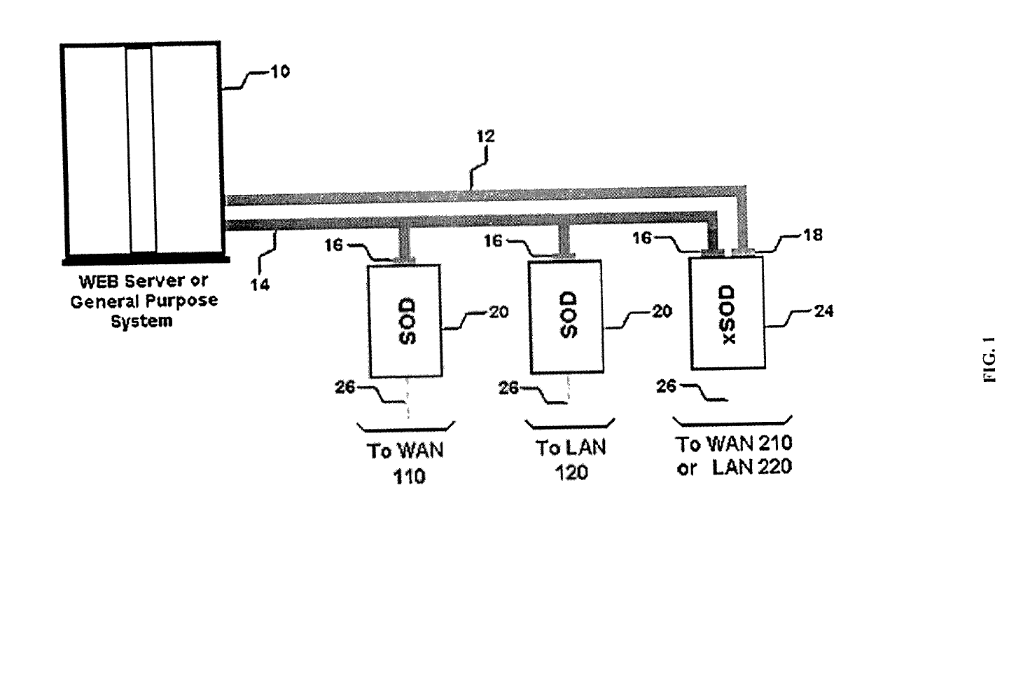

FIG. 1 shows a simplified block diagram illustrating a Web Server or General-Purpose System 10 employing an exemplary embodiment of this invention. The SCSI Optical Device (SOD) 20 is a peripheral device to the Web Server or General-Purpose System 10 and is connected wherein the first means of the Small Computer System Interface (SCSI) Bus 14. The SCSI Bus 14 could be a B-Cable as it is known in industrial terms to describe a 68-wire cable for 16 bit Wide Ultra2 SCSI as defined in ANSI document X3.131-1994. Alternatively, the SCSI Optical Device (SOD) 20 is connected wherein the second means of an (Input/Output) I/O controller as a passive bus device using electrical bus standards such as VMS, ISA, PCI, PCI-X, CompactPCI and MiniPCI, as known in the art, or using optical bus standards such as InfiniBand™ Architecture (InfiniBand™ Architecture is a trademark of InfiniBand(SM) Trade Association) which is described in detail at http://www.infinibandta.org. The SCSI Optical Device (SOD) 20 provides an optical internetworking gateway to a Wide Area Network (WAN) 110 or a Local Area Network (LAN) 120.

Wide Area Networks (WANs) and Metropolitan Area Networks (MANs), provide intemetworking media for servers and clients also known as nodes located across town (Metro applications—MAN), across country (WAN), and around the world (long haul WAN applications). WAN and MAN nodes use wireless, private lines, and/or public lines for interconnection via routers, switches and Public Switched Telephone Network (PSTN). The media for WANs and MANs are the following:

Optical fiber using optical WAN protocols such as Synchronous Optical Network (SONET), Synchronous Digital Hierarchy (SDH), Dense Wavelength Division Multiplexing (DWDM), and Wavelength Division Multiplexing (WDM) as known in the art;

Copper wire using WAN and MAN protocols such as Asynchronous Transfer Mode (ATM) and Frame Relay protocols as known in the art;

Wireless using wireless protocols such as Code Division Multiple Access (CDMA) and Time Division Multiple Access (TDMA) as known in the art. For wireless, connections to the antenna are usually fiber or copper, but the antenna could be connected as a passive bus device.

Since WAN and MAN share the same characteristics, MAN can be considered to be a special case of WAN. Therefore, the term WAN will be used for the remainder of the description and in the claims to refer to both WAN and MAN applications.

Local Area Networks (LANs) provide internetworking media for servers and clients also known as nodes located within 1000 meters of each other (short haul applications). LAN nodes use hard wire and wireless connections for interconnection via routers, bridges, and hubs. The media for LANs are optical fiber, copper coaxial or twisted pair wires, and wireless using ETHERNET® protocol (ETHERNET is a registered trademark of the Xerox Corporation).

A Web Server or General-Purpose System 10 is usually a main frame or large mini computer, as is known in the art. Web Server or General-Purpose System 10 provides mass storage for Internet related information and other resources for all of the WAN 110 and/or LAN 120 connections. Web Server or General-Purpose System 10 may also have print spooler and other functions that may be required by the WAN 110 or LAN 120.

WAN 110 and LAN 120 are often referred to as IP networks since they utilize the internetworking protocol TCP/IP, as is known in the art and fully described in D. E. Cormer, Internetworking with TCP/IP, Volume 1: Principles, Protocols, and Architecture, Second Edition, Prentice Hall, 1991. However, TCP/IP protocols are layers 3 and 4 in the Open Systems Interconnection (OSI) seven (7) layer reference model established by the International Organization for Standardization (ISO), Switzerland, and described in W. Stallings, Data and Computer Communications, Third Edition, Macmillan Publishing Company, 1991. Thus, layers 1 and 2 of the OSI model are often use different protocols for WANs verses LANs. As an illustration, WANs commonly use Frame Relay or (Asynchronous Transfer Mode) ATM protocols where LANs use ETHERNET protocol, either version 1 or version 10. This results in an incapability with the two networking media. Therefore, in prior art when a Web Server or General-Purpose System 10 required internetworking to a WAN 110, it would be a node on a LAN 120 and communicate with Gateway System that would be another node on the LAN 120. Gateway System would provide the connection to the WAN 110. When a message is transmitted over the WAN 110, it would be received by Gateway System. Gateway System would provide firewall protection by insuring the request is from an authorized source by examining INTERNET protocol, as is known in the art. With a valid request, Gateway System would then packetize the request in an ETHERNET protocol and forward the request to a Web Server or General-Purpose System 10 using the intra-networking of LAN 120. Web Server or General-Purpose System 10 would perform all LAN protocol handling in the Open Systems Interconnection (OSI) seven (7) layer reference model to service the request. No computer virus checking is performed.

When a Web Server or General-Purpose System 10 finds the requested information, it would packetize it in a LAN protocol such as ETHENET and return the information to Gateways System by communicating on the LAN 120. Gateway System receives the requested information from the LAN 120 and would perform all LAN protocol handling in the OSI seven (7) layer reference model. Gateway System would place the requested information in a WAN protocol, for example ATM and transmit on the WAN 110. If the WAN 110 is an optical fiber, Gateway System would translate and signals from electrical to optical as part of the transition sequence. With this arrangement, significant overhead is required to service a single request in the form of intra-networking on the LAN 120 and computing resources of Web Server or General-Purpose System 10. In fact, more then 50% of the CPU resources of Web Server or General-Purpose System 10 could be used on handling network protocols. The network protocols used here are for illustrative purposes only, as this invention may be used with any WAN or LAN protocols.

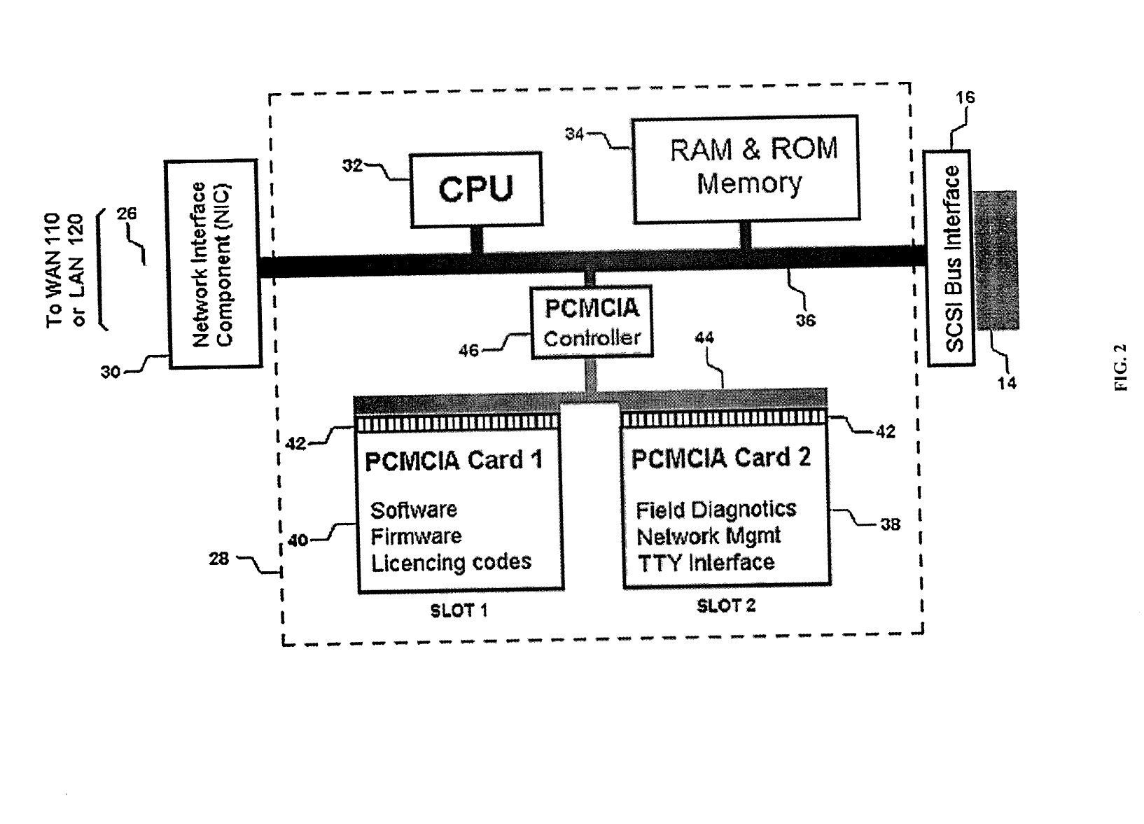

FIG. 2 is a block diagram illustrating the main components of the SCSI Optical Device 20. SCSI Optical Device 20 is, in this exemplary embodiment, divided into Network Interface Component (NIC) 30, Network Access Controller (NAC) 28, and SCSI Bus Interface 16. Network Interface Component (NIC) 30 provides the physical connection using optical fiber 28 to the WAN 110 or LAN 120 and handles the necessary physical layer protocols (layer 1) in the OSI 7-layer reference model. SCSI Bus Interface 16 provides a dedicated connection to a Web Server or General-Purpose System 10 by means of a SCSI Bus 14, as is known in the art. The SCSI Bus interface could be a 68 Pin Micro-D (wide high-density) connector with male connector for SCSI Bus 14 and female connector for SCSI Optical Device 20.Connectors are available from CablingDirectory, described in detail at http://www.CablingDirectory.com.

Network Access Controller (NAC) 28 is dedicated to handling the remaining six (6) protocol layers in the OSI 7-layer reference model and providing firewall security and computer virus detection. The network layer (layer 2) is specific to either WAN 110 or LAN 120 being employed. To perform the necessary processing, NAC 28 uses CPU 32, which is a processor, for example a Pentium™ processor chip, made by INTEL CORPORATION™ from Santa Clara, Calif. CPU 32 could be more than one processor depending on the OC rate of the optical (fiber) connection. However, processing power is not restricted to only processor chips. Complex Programmable Logic Devices (CPLD) such as Application Specific Integrated Circuits (ASIC) and Field Programmable Gate Array (FPGA) devices can also supply processing power. When CPU 32 is more than one processor, the set of processors will run in parallel, independent of each other. CPU 32 is under control of software/firmware programs stored in RAM and ROM Memory 34. The software programs specify the Operations, Administration, Maintenance, and Provisioning (OAM&P) that are required in handling the networking task. Buffering of data that was been received from the network, or needs to be transmitted is done in RAM Memory 34.

The OAM&P software programs are provided, in the preferred embodiment, on a 68-Megabyte PCMCIA (Personal Computer Memory Card International Association) Card 40 using release version 2.1 as is known in the art. PCMCIA Card 38 provides additional software programs or Network Management. PCMCIA or PC Cards, as is known in the art, are credit-card-sized devices that can be easily plugged into or removed from a slot on a computer. PC Card provides additional non-volatile memory, TTY or LAN capabilities, and even disk storage access and is fully described in M. Mori, PCMCIA Developer's Guide, Sycard Technology, 1999. Standards and release specifications are governed by PCMCIA, 2635 North First Street, Suite 209, San Jose, Calif. 95134 and are described in detail at http://www.pc-card.com. The PC Card offers a Plug 'n Play ability, as is known in the art. Alternatively, OAM&P software programs could be provided on a large “hard” disk system, EEPROM, PROM or some other form of occasionally writable, non-volatile memory. The OAM&P software programs may be updated by removing PCMCIA Card 40 and replacing it with a different PCMCIA Card that contains the updated programs. The updating procedure will be hot-swapable, meaning NAC 28 remains running while the update is taking place. For more sophisticated systems, OAM&P software programs could be updated over the SCSI Bus 14 by requesting a new copy from a Web Server or General-Purpose System 10.

Transfer of data is done using the PCI Bus 36 as is known by the art. Data transfer is done via direct memory access, as is known by the art, under control of CPU 32. The PCI Bus 36 permits transfer of data between the following components: RAM Memory 34, Network Interface Component (NIC) 30, SCSI Bus Interface 16, and PCMIA Cards 40 & 38. PCMCIA Card 40 & 38 use an internal PCMCIA Bus 44 and a PCMCIA Controller 46 such as Cirrus Logic CL PS6700 chip, from Cirrus Logic Incorporated Fremont, Calif., to access the PCI Bus 36. PCI Bus used here is for illustrative purpose only, as this invention may be used with any Bus arrangement, such as PCI-X Bus, CompactPCI Bus, MiniPCI bus, ISA Bus, or even Optical Bus.

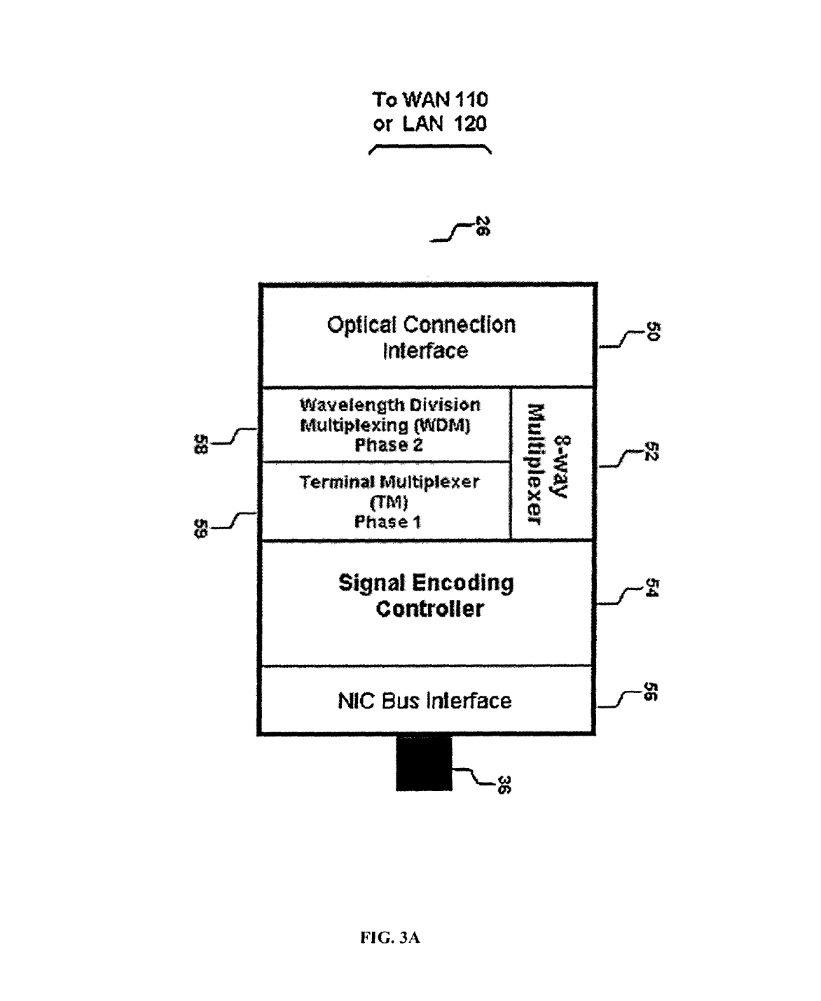

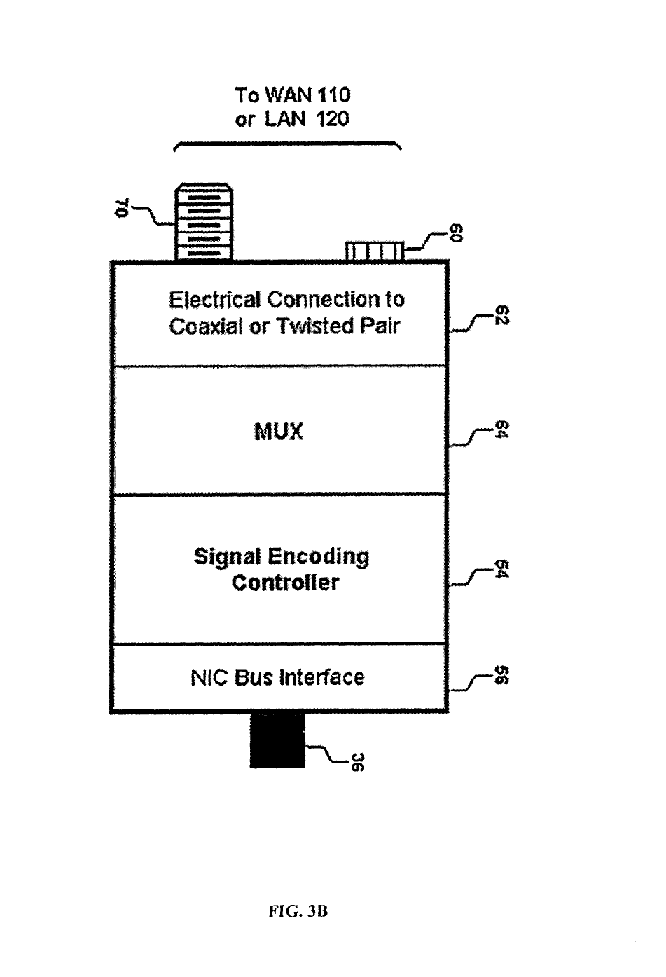

FIG. 3A is a block diagram illustrating the main components of the Network Interface Component (NIC) 30. Today, most WAN fiber communications use either SONET (Synchronous Optical Network) standard or SDH (Synchronous Digital Hierarchy) standard, as is known by the art. Since SONET is used in North America, and SDH is used in much of the rest of the world, the NIC 30 is removable and will only handle one of these standards at a time. To change from one standard like SONET to the other standard like SDH, would only require replacing SONET NIC with SDH NIC. The Network Interface Component 30 is divided into four logical components. The Optical Connection Interface 50 connects the optical fiber 26 to 8-way Multiplexer 52. 8-way Multiplexer 52 is responsible in handling the above SONET/SDH standards. 8-way Multiplexer 52 consist of two phases. Phase 1 is the Terminal Multiplexer 59, which converts electrical signals in a form called Synchronous Transport Signal (STS) into the higher-speed SONET/SDH optical form on transmission and SONET/SDH optical form into STS on receiving. Phase 2 performs the process named Wavelength Division Multiplexing (WDM) 58, which is the process of sending more then one color (frequency) of light on a single fiber. WDM 58 refracts the multiple colors of light into a single stream for transmission. On the receiving side, WDM 58 breaks the single stream of light into their separated beams of color. By having the capability to handle eight wavelengths (colors) of light on a single fiber, the NIC 30 provide the process called Dense Wavelength Division Multiplexing (DWDM) as is known by the art. If transmission involving different lower speed OC rates becomes an issue, a Phase 3 using an Add/Drop Multiplexer (ADM), as known in the art, can be added to deal with this issue.

The NIC 30 is not required to send all transmissions in a multiplex mode. The WDM 58 can be removed, and the NIC 30 can provide one, two, or four separate channels. The Optical Connection Interface 50 would be modified to have one, two, or four optical connectors with respect to the number of channels that are offered.

Continuing with FIG. 3A, Signal Encoding Controller 54 has the function of converting data packet signals into Synchronous Transport Signal (STS) packets. Signal Encoding Controller 54 would consist of a receiver and transmitter under the control of a Digital Signal Processor (DSP); DSP is under control of a program stored in ROM or EEPROM, as is known in the art and packets would be stored in local RAM (circuitry not shown). For transmissions, Signal Encoding Controller 54 transfers data packet from NIC Bus Interface 56 to local RAM. Under control of DSP, data packet is converted to STS packet and transferred on to 8-way multiplexer 52 by means of the transmitter. For receiving, STS packet is received from 8-way multiplexer 52 by means of the receiver and stored in local RAM. Under control of DSP, STS packet is converted to data packet, which is transferred to NIC Bus Interface 56 and RAM Memory 34 (See FIG. 2) via direct memory access, as is known in the art. By using EEPROM to store program control for DSP, protocols can easily be updated, changed, or replaced with a different protocol. WAN networking protocols used in the NIC 30 are for illustration purposes only as NIC 30 of this embodiment may be used with any LAN protocols. By replacing a WAN NIC with a LAN NIC and loading the appropriate OAM&P software located on PCMCIA Card 40 (See FIG. 2), SOD 24 is converted from a WAN networking device to a LAN networking device.

Referring to FIG. 3B, the network interfacing has changed for NIC 30 to Electrical Connection 62. There is an enormous copper wire infrastructure that exists today, especially in metropolitan areas and will take several years to be replaced by fiber or conjointly work with fiber. In order to permit SOD 24 to be used with this existing infrastructure, NIC 30 was modified with Electrical Connection 62, which permits copper wire connections to WAN 110 or LAN 120 networks. Connector 60 is the female interface for a (Registered Jack) RJ-45 connector, as is known in the art, for interfacing to LAN 120. For WAN 110, Connector 60 is a female interface for a RJ-48 connector. Both RJ-45 and RJ-48 use twisted pair wiring, as is known in the art. Connector 70 is the male interface for a (Radio Government) RG-58 connector for interfacing to WAN 110 or LAN 120 by using coaxial cable or “coax” as is known in the art.

The other modification that is needed with NIC 30 is the replacement of the 8-way Multiplexer 52 with a MUX 64. MUX 64 is a multiplexer used to transmit and receive multiple electrical signals across a single communication channel (wire). Several methods are available for accomplish the multiple signaling. Two of the most commonly used methods are Frequency Division and Time Division. The MUX signaling methods used here are for illustrative purposes only, as this invention may be used with any method for multiple signaling over a single channel. The rest of the NIC 30 remains intact since the same signal encoding and data transfers are the same for both electrical and optical networking.

This modified NIC 30 is not required to send all transmissions in a multiplex mode. The MUX 64 can be removed, and the NIC 30 can provide one, two, or four separate channels. The Electrical Connection 62 would be modified to have one, two, or four RG-58 connectors with respect to the number of channels that are offered Both RJ-45 and RJ-48 have sufficient number of twisted pairs that can handle up to four channels.

Returning to FIG. 1 simplified block diagram illustrating a Web Server or General-Purpose System 10 employing a second exemplary embodiment of this invention. The Extended SCSI Optical Device (xSOD) 24 is a peripheral device to the Web Server or General-Purpose System 10 and is connected by the means of Small Computer System Interface (SCSI) Bus 14 and Fibre Channel Arbitrated Loop (FC-AL) Bus 12. FC-AL Bus is an optical bus and is an ANSI specification supported by SCSI-3. An optical bus eliminates the need to convert optical signals to electrical signals and back to optical signals. The method for the initial version of xSOD 24 would be to utilize both SCSI Bus 14 and FC-AL Bus 12.

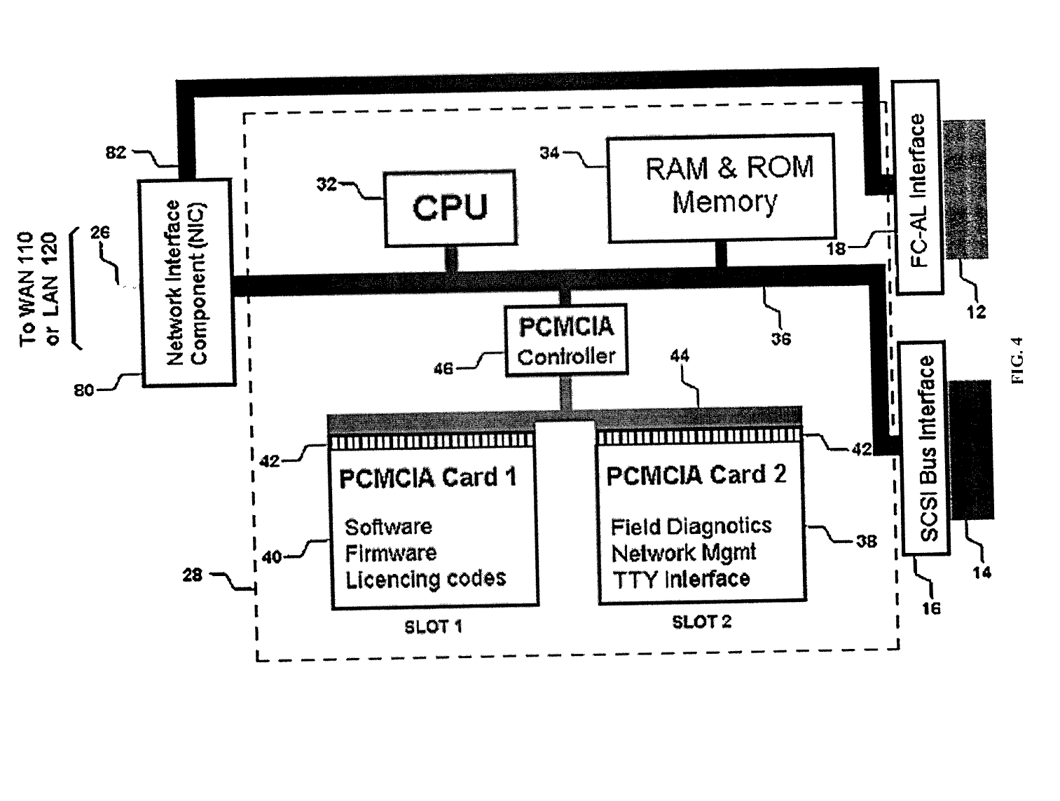

FIG. 4 is a block diagram illustrating the main components of extended SCSI Optical Device (xSOD) 24. Extended SCSI Optical Device 24 is, in this exemplary embodiment, utilizes the same components as SOD 20: modified Network Interface Component (NIC) 80, Network Controller 28, and SCSI Bus Interface 16. Request from WAN 110 or LAN 120 would be handled the same as SOD 20. The new components, Internal Optical Bus 82 and FC-AL Interface 18 in this exemplary embodiment, would be used for transmission of responses from Web Server or General-Purpose System 10. The responses from Web Server or General-Purpose System 10 would be sent across FC-AL Bus 12 that is connected to xSOD 24 using FC-AL Interface 18, then continues to modified NIC 80 using Internal Optical Bus 82.

FIG. 3A is a block diagram illustrating the main components of the modified Network Interface Component (NIC) 80. Modified Network Interface Component (NIC) 80 is, in this exemplary embodiment, utilizes the same components as NIC 30 (See FIG. 3A): Optical Connection Interface 50, 8-way Multiplexer 52, Signal Encoding Controller 54, and NIC Bus Interface 56. The new component is Optical Feed 84. Optical Feed 84 is in this exemplary embodiment, the method to send a response from Web Server or General-Purpose System 10 directly to WDM 58 as an optical signal for transmission on WAN 110 or LAN 120. Optical Memory (not shown) would be utilized to buffer transmission request until other tasks are completed by WDM 58. As optical processors become economically viable, the entire xSOD 24 will be transformed into a complete optical device that would utilize only FC-AL Bus 12 and eliminate the need for SCSI Bus 14.

While a preferred embodiment of the present invention has been set forth in detail, those skilled in the art who have reviewed the present disclosure will readily appreciate that other embodiments can be realized within the scope of the invention. For example, when a specific hardware or software protocol is disclosed, its equivalents can be used instead (e.g., USB instead of SCSI). Therefore, the present invention should be construed as limited only by the appended claims.

We claim:

1. A method for providing an internetworking interface as a peripheral device to a computing system, the method comprising:
providing an apparatus comprising a first connector for connecting the apparatus to the computing system as a peripheral of the computing system, a second connector for providing the internetworking interface, and a circuit for providing communication between the first connector and the second connector;
connecting the apparatus to the computing system as a peripheral of the computing system by use of the first connector;
connecting the apparatus to a network by use of the second connector; and
internetworking the network and the computing system through the first connector, the circuit, and the second connector.

2. A method in accordance with claim 1, wherein the network is a WAN, and wherein the second connector is an optical connector.

3. A method in accordance with claim 1, wherein the network is a WAN, and wherein the second connector is an copper connector.

4. A method in accordance with claim 1, wherein the network is a WAN, and wherein the second connector is a wireless connector.

5. A method in accordance with claim 1, wherein the network is a LAN, and wherein the second connector is an optical connector.

6. A method in accordance with claim 1, wherein the network is a LAN, and wherein the second connector is an copper connector.

7. A method in accordance with claim 1, wherein the network is a LAN, and wherein the second connector is an wireless connector.

8. A method in accordance with claim 1, wherein the internetworking step comprises handling seven-layer ISO protocols and providing network security.

9. A method in accordance with claim 1, wherein the apparatus supports plug-and-play administration.

10. A method in accordance with claim 1, wherein the internetworking step comprises remote network management of the apparatus.

11. A method in accordance with claim 1, wherein the apparatus can be changed from handling WAN protocols to LAN protocols by use of an interchangeable component.

12. A method in accordance with claim 1, wherein the apparatus can be used in either a copper wire network or optical fiber network by use of an interchangeable component.

13. A method in accordance with claim 1, wherein the internetworking step comprises total optical connectivity.

14. An apparatus for providing an internetworking interface as a peripheral device to a computing system, the apparatus comprising:
a first connector for connecting the apparatus to the computing system as a peripheral of the computing system;
a second connector for providing the internetworking interface; and
a circuit for providing communication between the first connector and the second connector.

15. An apparatus in accordance with claim 14, wherein the first connector comprises a passive bus connector.

16. An apparatus in accordance with claim 14, wherein the second connector comprises fiber optics for connecting to a WAN.

17. An apparatus in accordance with claim 14, wherein the second connector comprises copper wire for connecting to a WAN.

18. An apparatus in accordance with claim 14, wherein the second connector comprises an antenna (wireless) for connecting to a WAN.

19. An apparatus in accordance with claim 14, wherein the second connector comprises fiber optics for connecting to a LAN.

20. An apparatus in accordance with claim 14, wherein the second connector comprises copper wire for connecting to a LAN.

21. An apparatus in accordance with claim 14, wherein the second connector comprises an antenna (wireless) for connecting to a LAN

22. An apparatus in accordance with claim 14, wherein the circuit comprises a circuit for handling seven-layer ISO protocols.

23. An apparatus in accordance with claim 14, wherein the circuit comprises a circuit for providing both firewall protection and computer virus detection.

24. An apparatus in accordance with claim 14, wherein the circuit comprises a circuit for providing remote network management.

25. An apparatus in accordance with claim 14, wherein the circuit comprises a component for providing software and firmware, and wherein the component is hot swappable.

26. An apparatus in accordance with claim 14, wherein the circuit comprises a nonvolatile yet reprogramable electronic or optical memory device for providing software and firmware.

27. An apparatus in accordance with claim 14, wherein the circuit comprises means for accessing software and firmware on a disk system located either on a local or NFS file system.

28. An apparatus in accordance with claim 14, wherein the second connector comprises a replaceable network component to change the interface from a WAN to a LAN or from a LAN to a WAN without having to replace the entire apparatus.

29. An apparatus in accordance with claim 28, wherein the replaceable network component comprises a component to change the interface from optical fiber to copper wire or wireless; from copper wire to optical fiber or wireless; from wireless to optical fiber or copper wire without having to replace the entire apparatus.

30. An apparatus in accordance with claim 14, wherein the circuit comprises a replaceable component to change the apparatus from a multiplexing to a single channel device or a single channel device to a multiplexing device without having to replace the entire apparatus.

31. An apparatus in accordance with claim 14, wherein the second connector comprises a replaceable network component that can be reprogrammed to handle different physical layer protocols.
